(19) United States
(12) Patent Application Publication
(10) Pub. No.: US 2017/0323342 A1
(43) Pub. Date: Nov. 9, 2017

(54) ADVERTISEMENT MANAGEMENT BASED ON MOBILE RESOURCE PERFORMANCE

(71) Applicant: International Business Machines Corporation, Armonk, NY (US)

(72) Inventors: Kuntal Dey, New Delhi (IN); Vijay Ekambaram, Chennai (IN); Sougata Mukherjea, New Delhi (IN); Nitendra Rajput, Gurgaon (IN); Venkatraman Ramakrishna, Bangalore (IN)

(21) Appl. No.: 15/146,208

(22) Filed: May 4, 2016

(51) Int. Cl. G06Q 30/02; H04W 4/02

(52) U.S. Cl. CPC G06Q 30/0267; H04W 4/025; G06Q 30/0261; G06Q 30/0264

(57) ABSTRACT

Mobile device performance is predicted for a specified timeframe to drive selection of presentation media to be rendered on the mobile device during the specified timeframe. Further, mobile device context is determined for the specified timeframe according to current and historical context data. Presentations identified as suitable for a given context are delivered to the mobile device according to the determined mobile device context.

### BACKGROUND

The present invention relates generally to the field of advertising, and more particularly to displaying in-application advertisements on mobile devices, such as mobile phones and tablets.

System performance, as well as systems performance and computer performance, is characterized by the amount of useful work accomplished by a computer system or computer network compared to the time and resources used. Depending on the context, high system performance may involve one or more of the following: (i) short response time for a given piece of work; (ii) high throughput (rate of processing work); (iii) low utilization of computing resource(s); (iv) high availability of the computing system or application; (v) fast (or highly compact) data compression and decompression; (vi) high bandwidth; and/or (vii) short data transmission time. It is known how to monitor system performance to understand the user experience. Oftentimes, the data collected while monitoring system performance is used to improve the user experience.

### SUMMARY

In one aspect of the present invention, a method, a computer program product, and a system includes: identifying a mobile device to receive a presentation over a network, determining a set of presentations for delivery to the mobile device, selecting the presentation from the set of presentations based on a set of constraints related to the mobile device, the presentation having a pre-determined set of resource usage parameters that comply with the set of constraints, and sending the presentation to the mobile device for display on the mobile device.

### BRIEF DESCRIPTION OF THE SEVERAL VIEWS OF THE DRAWINGS

FIG. 1 is a schematic view of a first embodiment of a system according to the present invention;

FIG. 2 is a flowchart showing a method performed, at least in part, by the first embodiment system;

FIG. 3 is a schematic view of a machine logic (for example, software) portion of the first embodiment system;

FIG. 4 is a schematic view of a second embodiment of a system according to the present invention;

FIG. 5 is a swim lane diagram showing information that is helpful in understanding embodiments of the present invention.

### DETAILED DESCRIPTION

Mobile device performance is predicted for a specified timeframe to drive selection of presentation media to be rendered on the mobile device during the specified timeframe. Further, mobile device context is determined for the specified timeframe according to current and historical context data. Presentations identified as suitable for a given context are delivered to the mobile device according to the determined mobile device context. The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium, or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network, and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture, including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions, or acts, or carry out combinations of special purpose hardware and computer instructions.

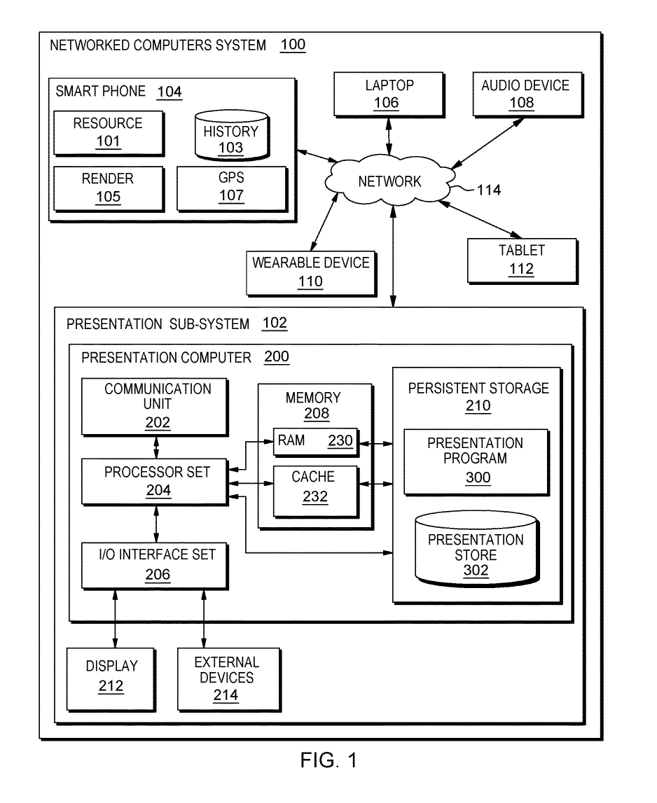

The present invention will now be described in detail with reference to the Figures. FIG. 1 is a functional block diagram illustrating various portions of networked computers system 100, in accordance with one embodiment of the present invention, including: presentation sub-system 102; smart phone sub-system 104, render module 105; historical context store 103; resource information module 101; GPS device 107; laptop sub-system 106; audio device sub-system 108; wearable device sub-system 110; tablet sub-system 112; communication network 114; presentation computer 200; communication unit 202; processor set 204; input/output (I/O) interface set 206; memory device 208; persistent storage device 210; display device 212; external device set 214; random access memory (RAM) devices 230; cache memory device 232; presentation program 300; and presentation store 302.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage, and control certain software functions that will be discussed in detail below.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware component within a system. For example, the communications fabric can be implemented, at least in part, with one or more buses.

Memory 208 and persistent storage 210 are computer readable storage media. In general, memory 208 can include any suitable volatile or non-volatile computer readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions, and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either, or both, physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with computer 200. For example, I/O interface set 206 provides a connection to external device set 214. External device set 214 will typically include devices such as a keyboard, keypad, a touch screen, and/or some other suitable input device. External device set 214 can also include portable computer readable storage media such as, for example, thumb drives, portable optical or magnetic disks, and memory cards. Software and data used to practice embodiments of the present invention, for example, program 300, can be stored on such portable computer readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the present invention. However, it should be appreciated that any particular program nomenclature herein is used merely for convenience, and thus the present invention should not be limited to use solely in any specific application identified and/or implied by such nomenclature.

Presentation program 300 operates to deliver presentations, such as advertising media, to a user device that are selected for delivery according to resource parameters such as current network and device states and context-specific use of the device. Presentations are either selected or assembled according to resource usage, which is compared with current or predicted device and/or network parameters. The term presentations in used herein as a payload for playback or display on a mobile device. A detailed example is provided herein where the presentation is an advertisement. However, as would be understood by a person of skill in the art based on the teachings herein, the presentation may contain other types of information, such as news stories or songs. Further, the presentation may be represented as text data, image data, video data, and/or audio data according to this disclosure.

Some embodiments of the present invention recognize the following facts, potential problems and/or potential areas for improvement with respect to the current state of the art: (i) advertisers may benefit from a system that detects when a user is in a high-bandwidth network; (ii) there is a need to provide advertisers with the ability to deploy advertisements optimized for the network environment available to the user at the time of deployment; (iii) presentations should be deployed in such a way that avoids a negative impact on application, or program, performance; (iv) deployment of a presentation that is not optimal for the environment in which the user device is located will lead to user dissatisfaction with the program as well as the presentation; (v) the approach that more advertisements imply more revenue is flawed in that it follows the law of diminishing returns; (vi) overload of advertisements results in a negative user experience; (vii) advertisements that overload a device on which they are displayed can be counterproductive and result in a negative user experience; (viii) users may stop watching a presentation or even stop using a corresponding program if the presentation causes a negative experience for the user; and/or (ix) conventional presentation systems consider only spatial placement of presentations on a particular user interface.

The term “performance” as used herein is in reference to system, or resource-based, performance. That is, the kind of performance that impacts the experience of the user to whom a presentation is directed instead of performance of the presentation to achieve a desired result.

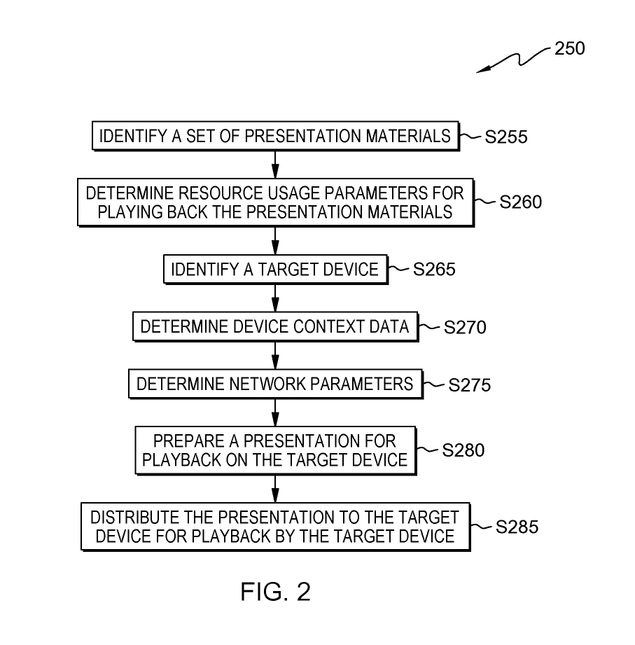

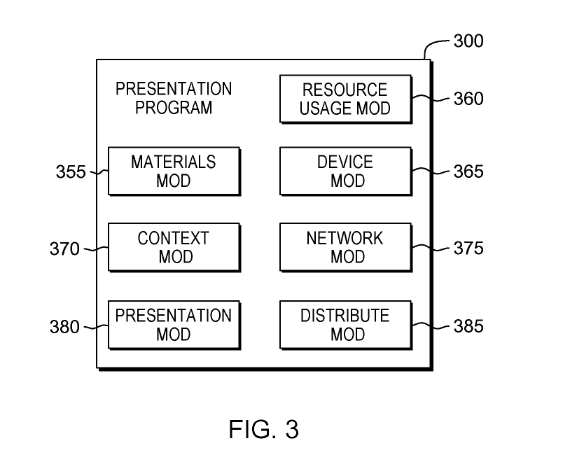

FIG. 2 shows flowchart 250 depicting a first method according to the present invention. FIG. 3 shows presentation program 300 for performing at least some of the method steps of flowchart 250. This method and associated software will now be discussed, over the course of the following paragraphs, with extensive reference to FIG. 2 (for the method step blocks) and FIG. 3 (for the software blocks).

Processing begins at step S255, where materials module (“mod”) 355 identifies a set of presentation materials. In this example, the materials mod receives a set of complete presentation materials for display on smart phone 104 (FIG. 1) and stores the materials in presentation store 302. Alternatively, a set of presentation snippets are stored in the presentation store to be combined according to some embodiments of the present invention. In some embodiments, the combination of certain snippets is performed with reference to a tag associated with a snippet. For example, similar tags are established for snippets that may be combined to create a single presentation. Regardless of how the presentation materials are identified, the presentation materials are formatted for display as text, video, or audio. As will be discussed further, multiple presentations having similar subject matter may be prepared for display in various formats.

Processing proceeds to step S260, where resource mod 360 determines the resource usage parameters for the presentation materials in the set of presentation materials. A corresponding resource usage value is assigned to each presentation according to the resource usage required for presenting to a user and according to one or more pre-determined devices on which the presentation may be displayed. In some embodiments, resource usage is determined by monitoring the display of the presentation materials in their various forms to determine their individual resource demands. Alternatively, resource usage is pre-determined and conveyed to the materials module when the presentation is received and/or stored.

Processing proceeds to step S265, where device mod 365 identifies a target device for transmission of the presentation materials. The target device, in this example, is smart phone 104 (FIG. 1) used by a target user. The target user is a subscriber for receipt of the presentation materials. In some embodiments, the target user registers the target device for later identification and receipt of presentation materials. Multiple devices, such as those shown in FIG. 1 may be registered for this purpose. In some embodiments, the target user provides user-preferences regarding receipt of presentation materials. Alternatively, the target device is identified as meeting target criteria and as in-use in a pre-determined geographic region. Alternatively, the device mod is contacted over network 114 (FIG. 1) by a device, such as tablet 112 so that it may be identified as a target device. In some embodiments, the target user is identified by a particular user identification and the user identification corresponds to one or more user devices, referred to herein as target devices.

Processing proceeds to step S270, where context mod 370 determines device context data over a given time frame for the target device identified in step S265. In this example, current device context data includes: (i) GPS data for a period of time, such as the last ten minute time period; (ii) location data for the period of time (location data as used herein refers to information about the nature of the location, such as a shopping mall or a doctor's office); (iii) mobile applications in use during the period of time; and (iv) remaining battery life of the smart phone. Other context data may be used for determining a device context. While those persons skilled in the art will recognize many sources of context data, additional or alternative context data may include: (i) user identification; (ii) subscribed services; available content on the target device; (iii) session time with respect to a particular application; (iv) target device health indicators; (v) environmental conditions; (vi) scheduled events; (vii) scheduled user activities; (viii) pre-defined download limits (e.g. target device service agreement); (ix) user demographic characteristics; (x) user behavior characteristics; (x) in-use application(s) characteristics (such as category, name, version, subscription status; file size); (vi) available network bandwidth; (vii) communication mode (for example, free WiFi, paid 3G); and (viii) characteristics of the target user's data plan. It should be noted that user device context determination technology is engaged for determining a context in which a user-device is operating. The various context parameters are disclosed herein as a basis for determining appropriate media presentation materials for disseminating to the user.

Some embodiments of the present invention periodically collect context data as context history data to be stored in historical context store 103 (FIG. 1). Context history data is useful in predicting a future context to follow the current context determined in this step (step S270). Prediction is also possible based on other context data discussed above, such as environmental conditions and/or scheduled events.

Context data may be obtained from various sources according to availability, both internal and external to the target device. Sources of context data include: (i) GPS; (ii) accelerometer; (iii) network management devices; (iv) social media activity, such as blog posts and status updates; (v) calendar of events; and (vi) user e-mail content. Persons skilled in the art will appreciate that there are many other sources of context data than are listed here as examples of sources.

Processing proceeds to step S275, where network mod 375 determines network parameters for a network connecting the target device to presentation sub-system 102 (FIG. 1). In this example, network parameters include: (i) bandwidth of network in-use by the target device; (ii) network type (e.g. 2G, 4G, WiFi); (iii) connection type; (iv) network connectivity speed; and (v) total, or remaining, monthly quota of gross network usage. One basis for determining the network parameters is that the nature of the user's data plan often dictates a download limit with additional fees for exceeding that limit. Providing many high-fidelity presentations may contribute heavily to a user exceeding the prescribed download limit.

Processing proceeds to step S280, where presentation mod 380 prepares a media presentation for delivery to the target device. In this example, the presentation mod selects a media presentation from the set of presentations that has resource usage characteristics that correspond to the determined device context and network parameters. Alternatively, a selection of one or more related presentation snippets is combined to generate a single presentation having usage characteristics that align with the determined device context and network parameters. Alternatively, the media presentation is prepared according to only the device context determination without regard to any network parameters. Alternatively, the media presentation is prepared according to only the network parameters without regard to any device context determination. Regardless of how a media presentation is prepared, the specific type and/or duration of the media presentation is determined with respect to the identified device context and/or network parameters. Resource usage characteristics include presentation-specific details having corresponding data points with respect to the target device. Resource usage characteristics include: (i) duration; (ii) data size; (iii) image or video resolution; (iv) image or video quality; (v) assigned requirements, such as display only when target device stationary, display with only specified presentation snippets, and/or for display over a 4G network; and/or (vi) screen size of the target device. For example, a text presentation is prepared for a target device having 20% battery life remaining that is operating in a 2G network. However, a high definition video presentation is prepared for a target device having 80% battery life remaining that is operating in a 4G network. Additional considerations may be involved in the preparation of the media presentation. Several additional considerations are discussed in more detail below.

Processing proceeds to step S285, where distribute mod 385 distributes the media presentation prepared in step S280 to the target device for playback by the target device. In this example, the playback occurs in real-time as the media presentation is distributed to the target device. Alternatively, the playback occurs according to a schedule based on a predicted occurrence of a particular device context in combination with a set of network parameters. In some embodiments, the prediction of target device context is based on context history data. Alternatively, the prediction of target device context is based on a set of pre-defined contexts drawn from the current device context. Pre-defined contexts include, for example, when a user context indicates that a user has just arrived at a movie theater, the predicted context is that the target device will be stationary for 2 hours and will only be available for rendering presentations for a next 15 minutes. That is, for a given device context or set of context information, a pre-defined prediction of future context information may be provided.

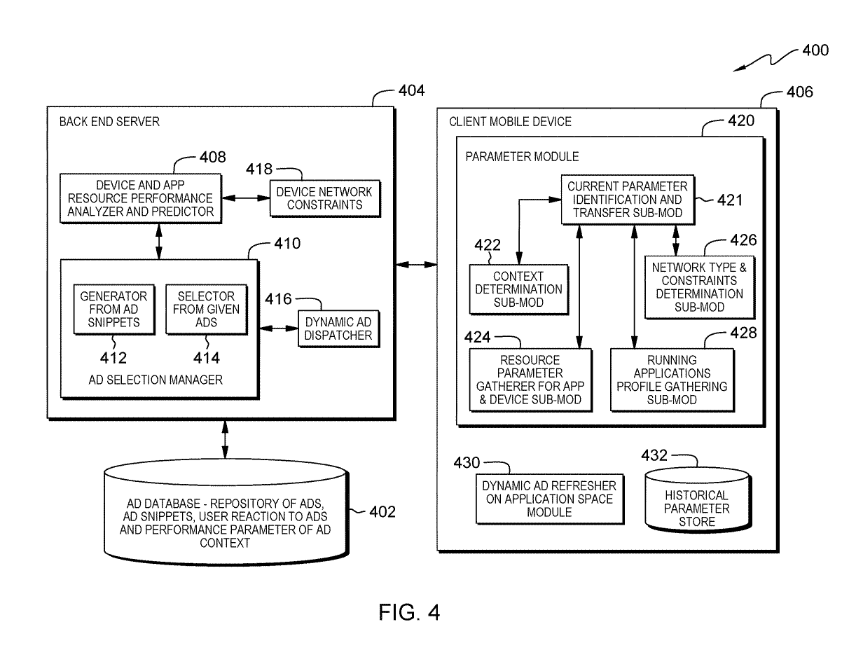

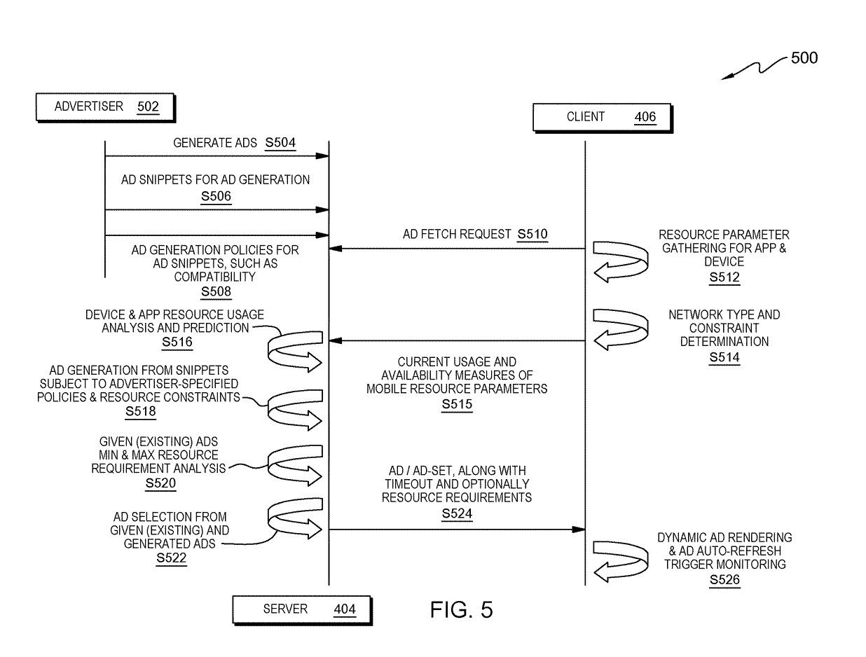

Further embodiments of the present invention are discussed in the paragraphs that follow and later with reference to FIGS. 4 and 5.

Some embodiments of the present invention are directed to a soft real-time system and associated methods to generate, select, dispatch, and/or dynamically render presentations with respect to a pre-determined context, which may be observed via monitoring of certain performance characteristics of a user device and/or a user network environment. Alternatively, instead of dynamic rendering, dynamic auto-refresh may be performed based on similar inputs. The term soft real-time, as used herein, a system where constraints (fidelity, delivery speed, as so forth) are more fluid than a hard real time system having rigid failure criteria. In a soft real time system, boundary criteria may be defined, but they are meant to be fluid. That is, the system is allowed to breach defined boundaries within a particular range allowing for a best-effort approach to boundary criteria.

Some embodiments of the present invention are directed to a soft real-time system and associated methods to generate, select, dispatch, and/or dynamically render presentations with respect to observed, inferred, and/or predicted mobile application performance.

Some embodiments of the present invention use input including: (i) an application running on a mobile phone; (ii) a set of contextual parameters, including health indicators and environmental conditions, that describe mobile phone usage in the present and near future; and/or (iii) a profile of the set of applications and background services running on the mobile phone. Alternatively, the profile of the set of applications and background services are not included as an input.

Some embodiments of the present invention generate as output a sequence of presentations meant to be relayed to the user while using an application on a target device.

Device resource conditions drive the selection and/or generation of presentations including the type of presentation displayed, whether audio, video, still images, and/or text. By collecting device resource states and predicting future states, targeted presentations are displayed according to the most suitable presentation type. In some embodiments, a sequence of individual presentations are prepared for display such that the subject matter and/or elements of the presentation change over time as the device resources change. That is, presentations are rendered at an appropriate frequency according to the resource availability and the presentations are re-rendered via auto-refresh as the resource state, or status, changes dynamically over time.

Determining which presentation display and when may take into account one or more of the following: (a) identification of presentations that have suitable content and fidelity for display; and/or (b) determination of when to display a particular presentation to a user according to the user and/or device context. Some embodiments of the present invention take into account a current and a predicted device state for determining a sequence for rendering a set of presentations on user device. In some embodiments, presentation display decisions apply a complex function involving all device state parameters such as parameters weighted, weights inferred through experimentation, and weight inferred through machine learning. Computed thresholds of each fidelity type and content type available are used to determine what subset of presentations pass the threshold and are, therefore, candidates for rendering on the user display. According to some embodiments, the computed threshold is recomputed at a pre-determined frequency for a particular set of presentations.

If device resource states permit, auto-refreshing presentations may be triggered after a specified timeout period (while the user remains on the same “page” of the app), versus not refreshing any presentation if the resource states do not permit (for example, when no candidate presentations pass the computed threshold).

In the following discussion, an example use is presented with respect to displaying advertising material to a user. It should be noted that many other uses of the present invention are envisioned, including presenting notices, providing instructions, and displaying warnings. It should be noted that important services will greatly benefit where the type of presentation is determined according to device context and network parameters for targeted display. The type of presentation includes one, or a combination, of video, audio, still images, and/or text.

An example use case follows. Three users are in a mall: User 1: 80% battery available, 512 kbps network bandwidth with 100 MB download limit remaining and is currently sitting; User 2: 20% battery available, 1 mbps network bandwidth with 50 MB download limit remaining and has been walking steadily; and User 3: 40% battery available, 256 kbps network bandwidth with 2 MB download limit remaining and is currently walking along an aisle of a shopping mall.

Each of the users are running the shopping mall's custom program to avail themselves of the best discounts in the nearby stores. The advertisements available for presentation are as follows: Ad 1 is a video ad requiring 2% battery, is well-displayed on a minimum 512 kbps network, uses 5 MB of data, and is good to display to idle users (for example, sitting at a food court); Ad 2 is a video ad requiring 5% battery, is well-displayed on a minimum 1 mbps network, uses 15 MB of data, and is forbidden to be displayed to any walking user; Ad 3 is a text ad box having three internal ads, uses 10 kb of data, and is good to show users under any context; and Ad 4 is a text ad box having one text ad, uses 12 kb of data, and is good to show to users who are in a state of motion (e.g. walking).

An example performance prediction is as follows: User 1 is expected to have similar resource requirements in the current as well as the next time slot, which is worth 10 minutes in this setting, with a battery drainage of 2%, and also is likely to keep walking; User 2 is predicted to drain 10% of her battery (given the resource consumption of the apps currently running), and is expected to remain sitting while using the mall's program; and User 3 is predicted to drain 1% of her battery, but is likely to keep walking for the next few minutes and then likely to be seated.

Advertisement, or ad, selection is as follows: User 1: Ad 1 is selected for the current time slot (Ad 2 is not selected as both the current and predicted state of context is walking, and that's not permitted by Ad 2), and Ad 4 is selected for the next time slot; User 2: Ad 3 is selected for this time slot, and Ad 1 for the next time slot; and User 3: Ad 4 is selected for this time slot, and Ad 3 for the next time slot.

FIG. 4 is a functional block diagram illustrating various portions of networked computers system 400 and corresponding software blocks, in accordance with one embodiment of the present invention, for determining advertising materials including: advertisement database 402; back end server 404; client mobile device 406; analyzer 408; advertisement manager 410; generator 412; selector 414; dispatcher 416; constraints store 418; parameter module 420; transfer sub-module 421 context sub-module 422; gatherer sub-module 424; constraints sub-module 426; profile sub-module 428; advertisement refresher module 430; and historical parameter store 432. FIG. 5 shows swim lane diagram 500 depicting method steps performed by networked computers system 400 and corresponding software blocks. This system and associated method will now be discussed, over the course of the following paragraphs, with extensive reference to FIG. 4 (for the system and software blocks) and FIG. 3 (for the method steps).

In particular, some embodiments of the present invention include: (i) a front end (or client) method to identify: a) a specified set of “current” (soft real-time) performance parameters and resource usages of a (i) mobile device, and (ii) applications of interest; b) the set of running applications on the mobile device with their resource usages; and c) resource and networking capabilities of the device, and expected usage requirements. The determination of context is performed by any now know or to be known device usage context determination system. These pieces of information are transmitted to the back end. Additionally, a back end method is included to select, from an existing set of mobile advertisements, a sequence of one or more advertisements for dissemination to the mobile application, suitable in the context and given performance parameters identified by the front end method.

Alternatively, or additionally, a back end method in included to generate advertisements, from advertiser-provided presentation snippets, for dissemination to the mobile application, suitable to the given context and given performance parameters. These snippets are generated in a variety of media types including video, audio, images, and/or text. Each type of media corresponds to individual resource constraints and, therefore, are individually suitable in certain usage contexts and performance parameters.

Some embodiments of the present invention are directed to a back end method to infer and to predict performance parameters of a client device, such as resource usage and productivity parameters. These performance parameters are used for advertisement selection and generation methods (that are also part of the system). A method, implemented as part of the mobile application advertisement insertion framework, is further implemented to determine whether or not to relay an advertisement to the user depending on current resource constraints. In some embodiments, selected advertisements are dynamically rendered and auto-refreshed via a soft real-time system by the back end server and then dispatched from the server after the selection process, as part of the application.

Some embodiments of the present invention are directed to dynamic render/auto-refresh. For example, the advertisements selected for the current timeframe may be shown immediately (replacing the ads that were already being displayed), optionally, comparing an ad rendering score (described in more detail below) with the currently shown ads, as well as these scores of the previous set of ads with a next timeframe indicating the current timeframe, while selecting ads for replacement. The ads selected for the next timeframe may be placed on hold, and processed in a similar manner.

Some embodiments of the present invention rely upon availability of technology, including: (i) a mobile phone context determination technology (such as Blue Zen); (ii) a set of capabilities or a technical toolbox to be able to gather mobile device resource usage statistics, in soft real time; and/or (iii) tools to determine the communication type (such as 2G/WiFi) and constraints (such as network bandwidth availability) of the device, using device-local or remote agents. (Note: the term(s) “BLUE ZEN,” “2G,” and/or “WIFI” may be subject to trademark rights in various jurisdictions throughout the world and are used here only in reference to the products or services properly denominated by the marks to the extent that such trademark rights may exist.)

Diagram 500 shows an example workflow for practicing some embodiments of the present invention. The process may be broken down into sub-tasks including: (i) generating the presentations and/or related presentation snippets; (ii) capturing performance parameters; (iii) resource performance prediction; (iv) selecting a presentation; (v) generating the presentation; and (vi) dynamic auto-refresh of the selected presentation.

Processing begins at step S504, where advertiser 502 generates a set of advertisements and provides those advertisements to back end server 404. Processing proceeds to step S506, where various advertisement snippets are generated. This step takes advantage of a capability to create a single advertisement by combining a selected set of snippets for presentation on a mobile device. Processing proceeds to step S508, where policies are applied to the various snippets, including the notion of snippet compatibility, or relatedness. In that way, only compatible snippets are assembled into a single advertisement. In some embodiments, compatibility of snippets is indicated by one or more metadata tags associated with a given snippet. The metadata tags provide compatibility information, such as by similar code or a sequence code suggesting that a particular sequence of snippets be used when generating a single presentation. In some embodiments, the metadata tags identify a particular product so that during combination of snippets, only snippets tagged with a particular product identifier, or tag, are available to be combined into a single presentation. In this example, advertisements, policy decisions, and advertisement snippets (including any metadata tags) are stored in ad database 402. Metadata tags indicating compatibility among snippets are sometimes referred to as combination identifiers.

Processing proceeds to step S510, where back end server 404 receives an advertisement fetch request from client mobile device 406. When request is received from a particular device and/or application, a list is also provided including a set of resources to be monitored (manually or semi-automatically) for the application and/or device and list of desirable contexts. Processing proceeds to step S512, where parameter module 420 collects resource parameter data for the device and/or a specified application running on the device. Resource parameters include context data as well as constraint data. For some embodiments, to honor the soft real-time constraints for each resource in the given context, a capture rate (frequency) is computed with respect to each resource for each context. In some embodiments, a list of running applications is generated along with their respective resource usages (CPU, memory, I/O activity, network usage, battery usage, etc.). When collecting the resource parameter data, the use of an available resource parameter gathering subsystem for the application or device, such as an existing application or device instrumentation subsystem, is relied upon. Further, an existing context determination system is also relied upon for collecting context data.

Processing proceeds to step S514, where constraint sub-mod 426 determines network type and identifies a set of network-based constraints. In this example, the determined device and/or network constraints are stored in constraints store 418. Network constraints are determined, in some embodiments, via operating system and network monitoring tools. Auxiliary inputs used to define device and/or network constraints include: (i) user demographics; (ii) device characteristics; (iii) network specifications; and/or (iv) network characteristics. Processing proceeds to step S515, where parameter transfer sub-mod 421 transfers current usage and availability measures of mobile resource parameters to analyzer 408.

Processing proceeds to step S516, where analyzer 408 analyzes and predicts device and/or application resource usage according to the usage and availability measures. In this example, a scored list is generated for expected resource performance over a next timeframe, for each resource. Alternatively, or additionally, a combined score of resource usage for a particular application or device is generated. Predicting performance considers, for each current resource usage parameter, a combined set of usage levels (for example, download rate), any remaining consumable levels (for example, battery life remaining, maximum monthly network bandwidth, free RAM, etc.), and auxiliary inputs, to infer overall current resource usage levels. When a performance prediction is combined with the prior resource usage parameters (recorded in resource parameter store 432), the resource performance and resource requirements may be predicted for a next timeframe, for each resource, as well as for a combination of resources. This combining process is carried out using statistical methods and machine learning methods.

Processing proceeds to step S518, where snippet generator 412 generates advertisements from snippets. Generation of the snippets draws upon information stored in constraints store 418 and ad database 402 so that advertiser-specified policies and resource constraints direct the generation of a single useable presentation, or advertisement, to be provided to for viewing on the user device. For example, an ad relevance score may apply to a given application or device. In some embodiments, for each advertisement relevant to the application or device, an expected resource requirement for each resource type is calculated. In some embodiments, permissions are established for set of contexts in which a particular ad or ad snippet may be displayed to a user (for example, a particular ad may not be displayed while a user is walking, and may only be displayed when a user is in a mall). Additionally, various advertisements are filtered out from selection due to available resource requirements of the advertisements. Selection is further accomplished by computing a resource requirement factor (number from 0 to 1, 1 requires high resource requirement, 0 requires no resource requirement) for each remaining advertisement, based on the weighted average of various related resource types and its expected resource requirements. In this example, the Bin-Bag optimization problem is applied such that the system outputs “K” ads with the following optimization constraint: maximize revenue (ad cost for ad providers) while minimizing resource requirements.

Generating advertisements from snippets is performed according to some embodiments of the present invention by receiving an ordered set of existing mobile ad snippets, along with a compatibility matrix capturing the compatibility of each pair of snippets, a sequence constraint matrix (a partial order) indicating which ad snippets can appear before or after which others, an upper limit constraint threshold (for example, a text length for text ads and a play time for video ads), and permissions for a set of contexts in which an ad snippet may or may not be displayed. Advertisements are generated by combining ad snippets based on the constraint matrices and upper limit thresholds. In some embodiments, for each generated advertisement, an ad relevance score is computed with respect to the given mobile application.

Processing proceeds to step S520, where given advertisement selector 414 selects advertisement fully prepared by advertiser 502 based on minimum and maximum resource requirement analysis performed by analyzer 408 in step S516.

Processing proceeds to step S522 where advertisement selection manager 410 selects advertisements for display from a selected set of given advertisements and custom generated sets of snippets. In some embodiments, selection and/or generation of the advertisement is dependent on a revenue value associated with each advertisement (such as a fee paid by an advertiser for display of an advertisement).

Processing proceeds to step S524, where dynamic advertisement dispatcher 416 transmits the selected advertisement(s) for display to the client device. The transmittal includes metadata directing timeout, optional resource requirements, and trigger data for auto-refreshing the advertisement selection process. The metadata is determined according to data stored in constraints store 418, advertisement database 402, and analysis and prediction generated by analyzer 408 at step S516. In some embodiments, the metadata includes a time indicator for indicating a policy as to when a particular advertisement is dynamically refreshed on the current web page (for example, “now,” “in 10 seconds,” “when available RAM falls below 30%,” “once the client clicks through to the next page,” “when the user starts walking,” etc.).

Processing proceeds to step S526 where advertisement refresher module 430 renders the transmitted advertisement(s) for display on the client device and monitors for an auto-refresh trigger. In that way, monitored output is periodically transmitted to the back end (not shown), either immediately or at the best chance, to the back end, according to soft real-time constraints.

Some embodiments of the present invention apply the following method to dynamic advertisement auto-refresh including: (i) as a one-time activity, define a compatibility matrix, indicating which kinds of advertisements can replace which others (for example: advertisements with “when the user starts walking” cannot replace another advertisement which also is “when the user starts walking,” and “one ad of size 3p×q pixels can be replaced by 3 advertisements of sze p×q pixels,” and ads with “when available RAM falls below 30%” are independent of advertisements that can be displayed “in 10 seconds.”); (ii) if no advertisement is yet rendered on the mobile application, show all the advertisements marked “now,” as well as attempt to show all the other advertisements that can be possibly run given the resource states and current performance indicators; and (iii) if the session is ongoing: a) for advertisements that were being rendered and need to be replaced, select the advertisements with compatible policies, and b) following the dynamic advertisement refresh policy specified with each advertisement, render the advertisements by replacing the old ones with the new ones (optionally, with new advertisements having advertisement rendering score values higher than the old advertisements), thereby having an impact equivalent to auto-refresh.

Some embodiments of the present invention are directed to a soft real-time system to generate (or compose), select, dispatch, dynamically render, and temporally auto-refresh presentation material, using device application and resource usage data along with predicted trends of device and resource usage. The predicted trends are based on an observed context, and observed, inferred, and/or predicted mobile application performance.

Some embodiments of the present invention are directed to a front end method to identify a specified set of “current” (soft real-time) performance parameters of a mobile device and applications of interest, and transfer this, along with the context of mobile phone usage, to the back end.

Some embodiments of the present invention are directed to a back end method, in which the inputs are a set of existing mobile presentations and the output is a set of presentations such that revenue for presentation management, if any, and/or for the presentation provider, if any, is maximized while maintaining certain resource thresholds of the application and/or mobile device. The thresholds, in some embodiments, are set with the objective of providing a user with a positive experience while viewing the presentation.

Some embodiments of the present invention are directed to a back end method for selecting, from an existing set of mobile presentations, a set of one or more presentations, for dissemination to the mobile application, suitable in the given context and given performance parameters.

Some embodiments of the present invention are directed to a back end method to generate presentations, from presenter-provided presentation snippets, for dissemination to the mobile application, suitable in the given context and given performance parameters.

Some embodiments of the present invention are directed to a back end method for inferring current and predicting future performance parameters such as resource usage and productivity parameters. The parameters are fed back to the presentation selection engine, such as ad selection manager 410 (FIG. 4).

Some embodiments of the present invention are directed to a method, implemented as part of a mobile application advertisement insertion framework, to dynamically render and auto-refresh advertisements by selection of replacement advertisements in soft real-time system by the back end server and dispatched from the server after selection, as part of the application.

Some embodiments of the present invention are directed to a method to dynamically compose a presentation either at the device or the server based on constraints where there already exists in the device or application a resource usage parameter gathering system to gather mobile device parameters and application parameters and a system, or tool, to determine the mobile device usage context.

Some embodiments of the present invention are directed to generating a set of presentations from presentation snippets for dissemination to the mobile application based on the performance context determination (modeling and prediction) from the mobile application and/or device, wherein the presentations generated are in various formats and/or media types (such as video, audio, and text) each presentation specifically suited for a particular pre-determined context.

Some embodiments of the present invention are directed to re-rendering presentations dynamically based on the performance context determination (modeling and prediction) of the mobile device and/or application. The term re-rendering refers to auto-refreshing the presentation based on the next timeframe, or time slice window, in which predicted performance is computed.

Some embodiments of the present invention are directed to predicting the performance load of the application for the next “X” seconds and expected performance load of the various presentations and based on these prediction, it selects presentations from the server which could work well within the predicted performance load limits yet maximizing any presentation revenue. In this way, the fidelity and the modality of presentations is improved over conventional approaches.

Some embodiments of the present invention operate independent of the application and/or device, being applicable to new situations without modifying the software.

Some embodiments of the present invention may include one, or more, of the following features, characteristics and/or advantages: (i) establishes an easy way to generate, select, and/or render in-application mobile advertisements that take into account mobile device performance; (ii) establishes an easy way to generate, select, and/or render in-application mobile advertisements that take into account resource performance parameters; (iii) recognizes when a high-resolution video advertisement may be deployed; (iv) recognizes when a plain text advertisement is a best way to display a particular advertisement; (v) recognizes when an audio advertisement is a best way to display a particular advertisement; (vi) estimates the performance of a mobile application in a particular context; (vii) renders advertisements that are optimal in load time within a particular context; (viii) renders advertisements that are optimal in resource consumption for a particular context; (ix) supports businesses in being smarter about deciding what ads to send and with what frequency; (x) determines and/or predicts with high confidence what advertisements can best be displayed on a user's device by knowing the current device state, trends and/or history for every device state parameter, context (such as location), and application usage; (xi) yields reasonably high precision and recall, in machine learning parlance; (xii) performance-based advertisement selection and/or generation; (xiii) dynamic auto-refresh of advertisement rendering based on performance prediction; and/or (xiv) enables effective selecting and scheduling of advertisements.

Some helpful definitions follow:

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

User/subscriber: includes, but is not necessarily limited to, the following: (i) a single individual human; (ii) an artificial intelligence entity with sufficient intelligence to act as a user or subscriber; and/or (iii) a group of related users or subscribers.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A method comprising:
identifying a mobile device to receive a presentation over a network;
determining a set of presentations for delivery to the mobile device;
selecting the presentation from the set of presentations based on a set of constraints related to the mobile device, the presentation having a pre-determined set of resource usage parameters that comply with the set of constraints; and
sending the presentation to the mobile device for display on the mobile device;
wherein:
at least the determining and selecting steps are performed by computer software running on computer hardware.

2. The method of claim 1, further comprising:
generating the presentation from the set of presentations so that the presentation complies with the set of constraints.

3. The method of claim 2, wherein:
the set of presentations includes a set of presentation snippets having individual resource usage parameters; and
each presentation snippet in the set of presentation snippets is tagged with a combination identifier that establishes a rule for generating the presentation from the set of presentation snippets.

4. The method of claim 3, wherein:
each presentation snippet is an advertising snippet;
the combination identifier is a product identifier; and
the presentation is a sequence of advertising snippets directed to a single product.

5. The method of claim 1, wherein the set of constraints includes device context data and in-use network parameters.

6. The method of claim 5, wherein device context data includes GPS data for a timeframe ending with a current time, location data for a timeframe ending with a current time, and a set of in-use mobile applications.

7. The method of claim 1, wherein determining the set of presentations for delivery to the mobile device includes selecting the set of presentations from an ordered list of presentation sets.

8. The method of claim 1, wherein selecting the presentation from the set of presentations includes:
establishing the set of constraints related to the mobile device by:
querying, over a timeframe, an accelerometer on the mobile device, and
determining a network type in use by the mobile device.

9. The method of claim 1, wherein:
a constraint in the set of constraints is remaining battery life of the mobile device, and
compliance with the remaining battery life constraint is achieved by a presentation having a pre-determined battery usage value less than the remaining battery life.

10. The method of claim 1, further comprising:
determining a start time for the presentation based on a predicted set of constraints for the mobile device; and
sending the start time to the mobile device to cause the mobile device to begin displaying the presentation at the start time.

11. The method of claim 1, further comprising:
receiving a batch of presentations assigned to a user identification; and
wherein:
determining the set of presentations for delivery to the mobile device includes:
associating the mobile device with the user identification; and
selecting the set of presentations from the batch of presentations based on the user identification.

12. A computer program product comprising a computer-readable storage medium having program instructions embodied therewith, the program instructions executable by a processor to cause the processor to:
identify a mobile device to receive a presentation over a network;
determine a set of presentations for delivery to the mobile device;
select the presentation from the set of presentations based on a set of constraints related to the mobile device, the presentation having a pre-determined set of resource usage parameters that comply with the set of constraints; and
send the presentation to the mobile device for display on the mobile device.

13. The computer program product of claim 12, further causing the processor to:
generate the presentation from the set of presentations so that the presentation complies with the set of constraints.

14. The computer program product of claim 12, wherein the set of constraints includes device context data and in-use network parameters.

15. The computer program product of claim 12, wherein determining the set of presentations for delivery to the mobile device includes selecting the set of presentations from an ordered list of presentation sets.

16. The computer program product of claim 12, wherein selecting the presentation from the set of presentations includes:
establishing the set of constraints related to the mobile device by:
querying, over a timeframe, an accelerometer on the mobile device, and
determining a network type in use by the mobile device.

17. A computer system comprising:
a processor set; and
a computer readable storage medium;
wherein:
the processor set is structured, located, connected, and/or programmed to run program instructions stored on the computer readable storage medium; and
the program instructions which, when executed by the processor set, cause the processor set to:
identify a mobile device to receive a presentation over a network;
determine a set of presentations for delivery to the mobile device;
select the presentation from the set of presentations based on a set of constraints related to the mobile device, the presentation having a pre-determined set of resource usage parameters that comply with the set of constraints; and
send the presentation to the mobile device for display on the mobile device.

18. The computer system of claim 17, further causing the processor set to generate the presentation from the set of presentations so that the presentation complies with the set of constraints.

19. The computer system of claim 17, wherein the set of constraints includes device context data and in-use network parameters.

20. The computer system of claim 17, wherein determining the set of presentations for delivery to the mobile device includes selecting the set of presentations from an ordered list of presentation sets.
